(19) United States
(12) Patent Application Publication
(10) Pub. No.: US 2014/0332424 A1
(43) Pub. Date: Nov. 13, 2014

(54) MOBILE TOOLBOX

(71) Applicant: Billy Poulin, Hudson, NH (US)

(72) Inventor: Billy Poulin, Hudson, NH (US)

(21) Appl. No.: 13/890,762

(22) Filed: May 9, 2013

(51) Int. Cl. B25H 3/02

(52) U.S. Cl. CPC B25H 3/02
USPC 206/349

(57) ABSTRACT

A toolbox is provided. The toolbox is configured to allow a single person to perform two person activities such as marking a chalk line, identifying right angles, and marking an arc. The toolbox forms one or a plurality of pins from its lower surface. An end of a chalk line tool may be attached to one of the pins for use.

### BACKGROUND OF THE INVENTION

1. Field of the Invention

The present invention relates generally to tool storage structures. More particularly, the present invention relates to a mobile toolbox having connectors to which a chalk line can be anchored.

2. Description of Related Art

Chalk line tools are common tools for identifying and marking out a straight line. They operate by dredging a string in chalk. The string may be drawn out, and secured between two points. The string may then be pulled taut and snapped or otherwise urged against a surface. Chalk from the string sticks to the surface, marking out a straight line.

However, because the string must be pulled taut, in almost all situations two operators must use the chalk line tool—one on each end holding it. This is inconvenient, especially for a single operator, or operators on a busy job or job site.

Further, identifying straight lines and right angles extending from a known line or point is often a two person job or time consuming one person job. Properly aligning a sighting device properly takes time, repeated measurements, and often a second user across a span to secure the device in position.

Further still, it is often quite difficult for a single user to mark out a proper arc of a given radius. In these cases, often one user must hold a string or similar radius marker, while a second user tracks out the arc along which the radius draws.

Therefore, what is needed is a device that may allow for a single user to easily, quickly and efficiently identify and mark down straight lines, arcs, and the like. The device may further provide storage for tools and provide multiple different functions.

### SUMMARY OF THE INVENTION

The subject matter of this application may involve, in some cases, interrelated products, alternative solutions to a particular problem, and/or a plurality of different uses of a single system or article.

In one aspect, a toolbox is provided. The toolbox is formed of a body defining an interior space. The body also provides access to the interior space. Extending from a bottom face or surface of the body is a pin. Attached to the pin is a first end of a chalk line tool. The chalk line tool is removably attachable to the toolbox. In some embodiments the pin may also support the toolbox body off the ground. In other embodiments, a foot or feet may support the toolbox body off the ground.

In another aspect, a toolbox is provided. The toolbox is formed of a body defining an interior space, and providing access to the interior space. Extending from a bottom face or surface of the body are a plurality of pins. In some embodiments, some or all of the plurality of pins may support the toolbox body off the ground. In other embodiments, a foot or feet may support the toolbox body off the ground. Of the plurality of pins, there is a first set of pins on a front bottom edge of the toolbox body having a first spacing between them. A second set of pins extend from a left side edge of the toolbox body with a second spacing between them. A third set of pins extend from a right side edge of the toolbox body with a third spacing between them. The first spacing, second spacing, and third spacing are different, such that the pins of each side are spaced at different intervals from each other. Each of the plurality of pins is configured to receive an end of a chalk line tool. The different spacing may correspond to common thicknesses for laying chalk lines such as common wall thicknesses.

### BRIEF DESCRIPTION OF THE DRAWINGS

FIG. 1 provides a side view of an embodiment of the toolbox.

FIG. 2 provides a front view of an embodiment of the toolbox.

FIG. 3 provides a side view of an embodiment of the toolbox.

FIG. 4 provides a rear view of an embodiment of the toolbox.

FIG. 5 provides a top view of an embodiment of the toolbox.

FIG. 6 provides an elevation view of a T shaped support having laser sights on its ends.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a toolbox having connection points for connection of a chalk line end, allowing a single operator to lay down chalk lines on floors and other surfaces. The toolbox is formed of a body defining an interior space that may fit tools, hardware, plans, and the like. A wheel or set of wheels may be attached to the tool box, allowing the toolbox to be rolled from point to point. A bottom of the toolbox body may be elevated from the ground. A pin or a plurality of pins may extend downward from the bottom of the toolbox body and may contact the ground or be elevated slightly above it. In varying embodiments, the pins may support the toolbox body above the ground, or separate feet may support and elevate the toolbox body.

The term chalk line is used herein to refer to a tool designed to be extended in a straight line and to make a chalk or similar imprint on a surface it is placed against. In one embodiment, the chalk line may be a spooled string in a housing filled or partially filled with chalk dust. The spooled spring may be drawn and retracted into the housing. Once out of the housing, the spooled string may be drawn taut between two points, and when urged against a surface, may make a line mark between two points along the surface. However, other embodiments of chalk line tools are also contemplated by this disclosure. Further, the chalk line tool may be separate from the toolbox, or may be an integral part of it.

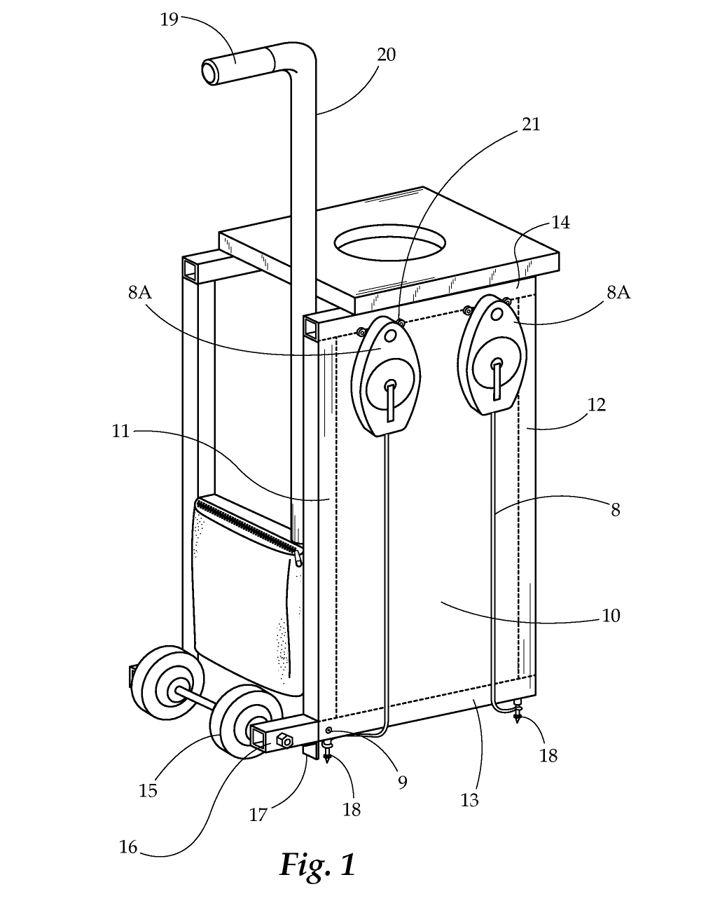

Turning now to FIG. 1 an embodiment of the toolbox is provided. In this embodiment, the toolbox is formed by framing 11, 12, 13, and 14. This framing extends in three dimensions to form the toolbox body in a box shape. Between the framing is a sheet 10. The sheet 10 and framing 11, 12, 13, 14 define the toolbox body, and define an interior cavity in which tools, hardware, plans, and the like may be stored. In varying embodiments, the toolbox body may be formed by folded or molded sheet metal, plastic, or the like, and may not require the structure provided by the framing. Further, while the toolbox body is shown as a substantially rectangular box, it should be understood that it can be any shape.

The framing 11, 12, 13, 14 and sheet may be formed of any material capable of forming and supporting the toolbox. Exemplary materials of which the framing and sheet material may be made include: metals, plastics, composites, wood, and the like.

A bottom portion of the framing 13 may form a post 16 extending beyond a rear of the toolbox to allow the attachment of a wheel 15 or wheels. The wheel 15 is configured to support the weight of the toolbox and contents therein when it is oriented to have its weight over the wheel 15. The wheel 15 is configured to allow easy movement and positioning of the toolbox.

A metal angle 17 acts as a foot to support the toolbox body off the ground. Similarly, in this embodiment, pins 18 also contact the ground, supporting the toolbox body. However, in some embodiments, the pins may extend but not quite reach the ground or floor. In this embodiment, the metal angle 17 extends a distance equal to or slightly greater than the bottom edge of the wheel 15. As such, the toolbox must be tilted towards the wheel 15 to allow the wheels to operate.

The pins 18 are configured to receive a free end of a chalk line tool. The end of the chalk line may be wrapped, pinned, or otherwise secured to, or held in place by, the pins. In the embodiment shown, each pin 18 has two circular extensions that extend from the outer circumference of the pin. These extensions may allow the chalk line end to be attached between them to prevent sliding of the chalk line. The pins 18 are, in this embodiment, located approximately six inches from each other. However, the spacing may vary.

In one embodiment, three of the four sides (front, left, and right) may have a set of two pins at the lower edges, each located a different width apart. The widths selected for pin spacing may be common wall thicknesses, such as 6 inches, 3⅝ inches, and 4 inches. However, it should be understood that in varying embodiments, one pin may be used, or the pins may be spaced at any distance from each other. Further, more than two pins may extend from one side.

In an embodiment of operation, the chalk line tool 8A may have a first string end attached to one of the pins 18. The chalk line tool may then be extended to an end point such as an opposite wall. Once the end point is reached, the chalk line may be snapped or otherwise activated, causing the chalk to form a line on the floor of which the toolbox is resting, from the toolbox to the end point. The toolbox is configured to be heavy enough to remain in place during this operation.

The embodiment of FIG. 1 further shows a handle 19 extending from framing 11 by post 20. The handle 19 may be configured to allow a user to easily tilt the toolbox back on the wheels 15, and to allow a user to orient the toolbox as required for applying the chalk line.

A clip 21 or other attachment device may be attached to the toolbox body to allow for storage of the chalk line tool 8A. Chalk lines 8 extends from two chalk line tools 8A, and have ends attached to pin 18. In operation, the chalk line tool 8A may be removed from clip 21, extended away from its attached end at pin 18, brought to a proper position, and the chalk line 8 may be snapped against the surface, leaving a straight line marked thereon. In this embodiment, two clips 21 are provided, allowing a belt loop clip of a chalk line tool to be attached. However, it should be understood that any structure such as a pocket, magnetic connector, strap, chain, or the like may be used to allow for storage of the chalk line tool. In this embodiment, two chalk line tools 8A are attached to the front, one to each clip 21 positioned on a top front of the toolbox body. A chalk line 8 of each tool 8A is attached to one of the pins 18 at a first string end. It should be understood that one or a plurality of chalk line tools may be attached and utilized by the present invention. In one embodiment, the chalk lines may be specially made to have a clip sized to mate with clip 21. It should be understood however that use a single chalk line tool 8A is also contemplated herein.

The embodiment of FIG. 1 further comprises a laser sight 9 or laser pointer built into the framing 11, 13. This laser sight 9 is aligned with the metal angle 17. The laser sight 9 may be used to identify a point on a wall or object that is in a straight line with the alignment of the toolbox. If the angle 17 is positioned against a point or surface, the laser sight 9 may be activated and may identify a point on a surface that extends in a straight line from the metal angle 17. In one embodiment, this point marked by the laser sight 9 may be the end point to which the chalk line tool is brought. The chalk line tool 8A may then be used to draw a straight line from the pin 18 to the reflection of the laser sight 9. Further, the laser sight 9 may be angled downwardly slightly such that it illuminates a straight line along a floor. In this embodiment, the laser sight may operate as the chalk line tool, or as a guide to make a more permanent line marking on the floor.

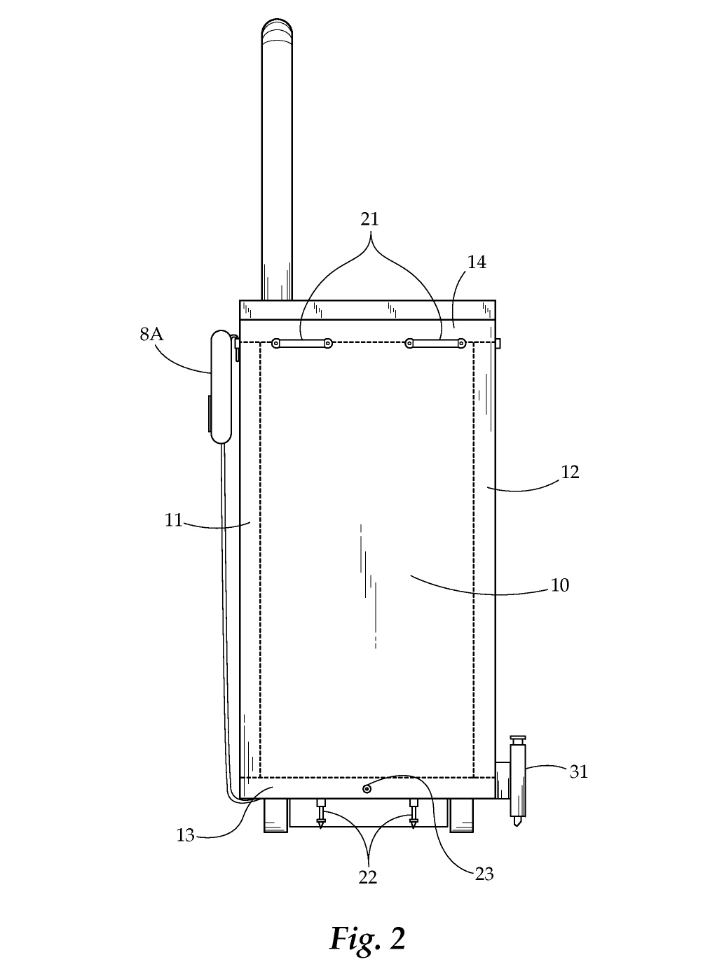

FIG. 2 shows another embodiment of a front of the toolbox. The framing 11, 12, 13, 14 and sheet 10 form a front face of the toolbox body. A laser sight 23 is built into a bottom of the toolbox body such as bottom framing 13, and positioned centrally along a width of the toolbox body. The laser sight 23 may operate similarly to laser sight 9 and may be operated simultaneously or independently of it. Pins 22 extend from the bottom of the toolbox body, and, in this embodiment, are spaced approximately 3⅝ inches apart.

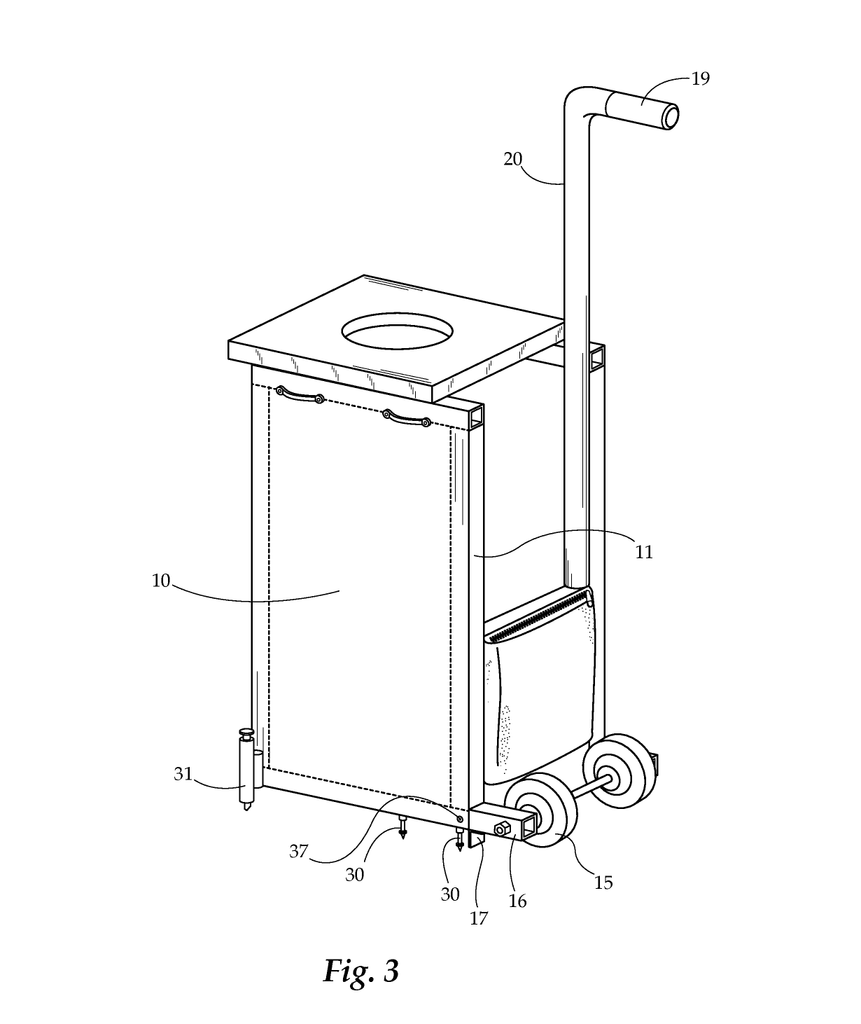

FIG. 3 provides a side view of another embodiment of the toolbox. In this embodiment, the framing 11, 12, 13, 14 and sheet 10 form a front face of the toolbox body. Clips 21 are positioned on a top front of the toolbox body, providing easy storage and accessibility to the chalk line tool (not shown). An extension 16 holds wheel 15. This wheel is slightly elevated above metal angle 17 and pins 30, such that it must be tipped back to allow the wheel 15 to roll the toolbox. A laser sight 37 is positioned and operates similarly to laser sight 9, on an opposite side of the toolbox. Laser sight 37 and laser sight 9 may be operated independently of each other or in tandem.

A radius tool 31 is attached to a front side of the toolbox. The radius tool 31 allows a user to extend a marker out a certain distance, and to draw, mark, or otherwise identify an arc having a radius of the certain distance. In other embodiments however, the radius tool 31 may be any structure that allows identification of an arc shape. It should be understood that the radius tool 31 may be positioned anywhere on the toolbox or toolbox body. For example, the radius tool 31 may be on the front, rear, or sides. Also, the radius tool 31 need not be positioned adjacent to the bottom of the toolbox, though in many embodiments this is the most efficient positioning.

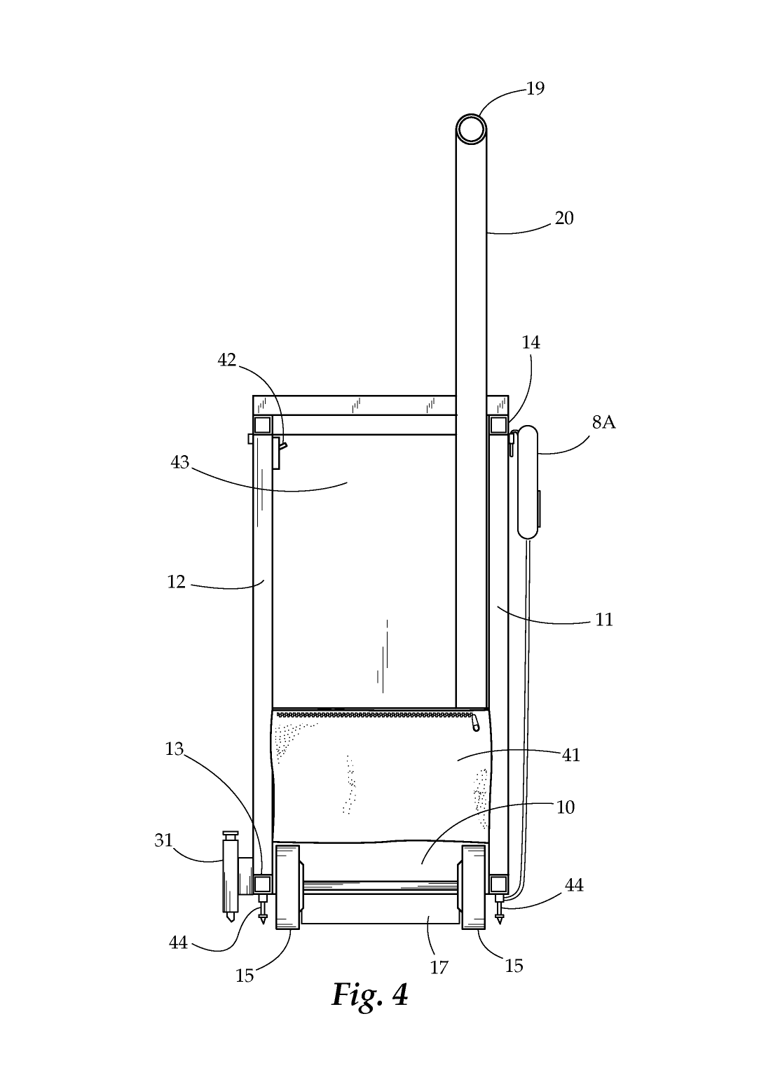

FIG. 4 provides a rear view of an embodiment of the toolbox. Framing 11, 12, 13, 14 and sheet 10 define the toolbox body. An open region is defined by a top edge of the sheet 10 and framing 11, 12, 14. The open region 43 allows access to an interior of the toolbox body. In varying embodiments, the open region 43 may be covered by a door, screen, flap, or the like. A switch 42 is positioned on a side wall inside the toolbox body interior. The switch 42 is configured to activate a laser sight shown in the previous figures. A power source (not shown) may power the laser sights. The power source may be mobile such as a battery, or a plug-in source such as a wall outlet or generator. In this embodiment, a bag 41 is attached to the rear of the toolbox body. This bag may supplement storage of tools, hardware, plans, and the like. In a particular embodiment, the bag 41 may be a canvas zippered bag. It should be understood however that alternative storage devices to the bag 41 may be attached to the rear of the toolbox body, such as a basket, bucket, or the like.

A face of the metal angle 17 can be seen under the toolbox body. This face 17 may be aligned with a track or other structure on a floor. Once aligned, lines may be established extending parallel or perpendicularly to this track by alignment of the metal angle 17. Further, arcs may be drawn with the radius tool 31 based on the alignment of the face 17 with a track.

Pins 44 are positioned on edges of the rear bottom framing 13. These pins 44 are slightly longer than a height of the wheels 15. As noted above, an end of the chalk tool may be secured to, or held by, the pin 44. A post 20 extends from side framing 11. A handle 19 is attached to the post 20, allowing convenient movement, orientation and control of the toolbox.

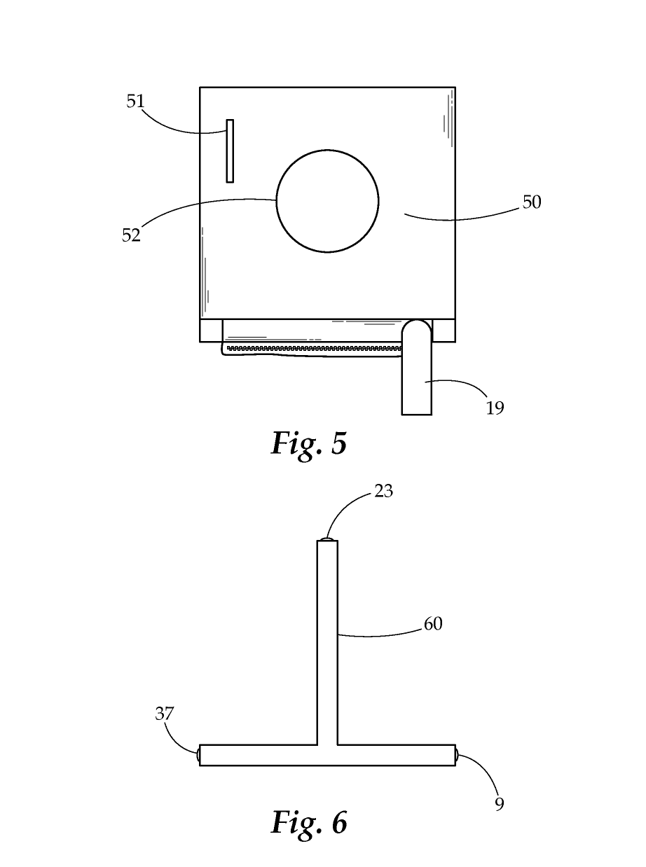

FIG. 5 provides a top view of an embodiment of the toolbox. In this embodiment, the top is formed by the top framing 14, and a cover 50. The cover may be formed of any material capable of covering the toolbox body, such as metal, plastic, wood, composites, and the like. The cover 50 may be removable, fixed, hingedly attached, slideably attached, and the like. The top cover 50 defines a circular aperture 52. This aperture may be used to store a chalk refill container (not shown), or other circular vessel such as a cup. The circular aperture 52 may also provide access to the interior of the toolbox body. The chalk refill container serves to refill chalk dust of the chalk line tool (not shown). It should be understood that apertures of varying shape may also be used instead of the circular aperture 52. Further, the cover 50 defines a slot 51. The slot 51 is configured to slidably receive and store a long thin item such as a carpenter's square or similar. The slot 51 may communicate with the interior cavity of the toolbox body, or with a separate sheath. A handle 19 is positioned on a rear left corner of the toolbox body.

FIG. 6 provides a view of the orientation of an embodiment of the laser sights 9, 23, 37. In this embodiment, the laser sights are attached to a T-shaped structure 60. This structure 60 may be attached to a bottom of the toolbox body, or may be integrated into a base of the toolbox, forming the bottom framing thereof.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A toolbox comprising:
a body defining an interior space;
a pin, the pin extending from a bottom face of the body;
a chalk line tool, the chalk line tool having a body and a first string end attached to the pin, and a free second end, the chalk line tool body being removably attachable to the toolbox.

2. The toolbox of claim 1 further comprising a plurality of pins, each of the plurality of pins extending from the bottom face of the body.

3. The toolbox of claim 2 wherein the plurality of pins comprises:
a first set of pins on a front edge of the bottom face of the toolbox body, the first set of pins having a first spacing between them;
a second set of pins on a left edge of the bottom face of the toolbox body, the second set of pins having a second spacing between them;
a third set of pins on a right edge of the bottom face of the toolbox body, the third set of pins having a third spacing between them;
wherein the first spacing, second spacing, and third spacing are different distances from each other.

4. The toolbox of claim 1 wherein a rear of the toolbox body defines an opening allowing access to the interior space.

5. The toolbox of claim 1 further comprising a radius tool attached to an outside of the toolbox body.

6. The toolbox of claim 1 further comprising a first laser sight attached to an outside of the toolbox body.

7. The toolbox of claim 6 further comprising a second laser sight and a third laser sight, the first and second laser sight oriented at a right angle from each other, the second and third laser sight oriented at a right angle from each other, the third laser sight being oriented opposite to the first laser sight.

8. The toolbox of claim of claim 6 further comprising a switch to activate the laser sight.

9. The toolbox of claim of claim 2 further comprising a plurality of chalk line tools removably attached to the toolbox body, a string end of one of the plurality of chalk line tools attached to one of the plurality of pins, and a string end of a second of the plurality of chalk line tools attached to a second of the plurality of pins.

10. The toolbox of claim of claim 9 wherein the cover defines an aperture passing through the cover, and sized to receive a portion of a carpenter's square.

11. The toolbox of claim of claim 9 wherein the cover defines an opening providing access to the interior space.

12. The toolbox of claim 1 wherein the toolbox body is formed by a framing and a sheet metal, the sheet metal connected to the framing and filling spaces defined by the framing.

13. The toolbox of claim 1 further comprising two wheels, the two wheels connected to the toolbox body and having a lower edge slightly higher than an end of the pin.

14. The toolbox of claim 1 further comprising a metal angle attached to the bottom of the toolbox body.

15. The toolbox of claim 1 further comprising a clip, the clip configured to receive the chalk line tool.

16. The toolbox of claim 1 further comprising a shaft extending from a top of the toolbox body, and a handle attached to an end of the shaft.

17. The toolbox of claim 1 further comprising a bag attached to a rear of the toolbox body.

18. A toolbox comprising:
a body defining an interior space;
a plurality of pins extending from a bottom face of the body, each of the plurality of pins constructed and arranged to receive a string end of a chalk line tool;
wherein the plurality of pins comprises:
a first set of pins on a front edge of the bottom face of the toolbox body, the first set of pins having a first spacing between them;
a second set of pins on a left edge of the bottom face of the toolbox body, the second set of pins having a second spacing between them;
a third set of pins on a right edge of the bottom face of the toolbox body, the third set of pins having a third spacing between them; and
wherein the first spacing, second spacing, and third spacing are different distances.

19. The toolbox of claim 18 further comprising a first laser sight attached to an outside of the toolbox body.

20. The toolbox of claim 18 further comprising a radius tool attached to an outside of the toolbox body.
